(19) United States
(12) Patent Application Publication
(10) Pub. No.: US 2014/0354494 A1
(43) Pub. Date: Dec. 4, 2014

(54) Wrist Worn Device with Inverted F Antenna

(71) Applicant: Daniel A. Katz, Kiryat Ono (IL)

(72) Inventor: Daniel A. Katz, Kiryat Ono (IL)

(73) Assignee: Daniel A. Katz, Kiryat Ono (IL)

(21) Appl. No.: 13/907,986

(22) Filed: Jun. 3, 2013

(51) Int. Cl. H01Q 1/27

(52) U.S. Cl. CPC H01Q 1/273
USPC 343/718

(57) ABSTRACT

The present invention discloses a wrist worn communication device, possibly integrated with a wrist watch, comprising a radio coupled to a low profile antenna. The antenna, obtaining low and medium angle elevation radiation enabling efficient satellite communications, is configured on the perimeter of the device, giving room for a display on top of this compact device. Preferably, the display is configured to indicate the time, but also possibly other parameters such as position, speed, altitude, temperature, air pressure, heart pace, messages, alarms and so on. According to a preferred embodiment of the present invention, said device is a Personal Locator Beacon (PLB) configured to broadcast distress signals detectable by satellites. According to another embodiment of the present invention, said radio is a GPS receiver.

### BACKGROUND OF THE INVENTION

The present invention relates to wireless communications and particularly to Radio Wave Antennas.

Efficiency of a transmitting antenna is usually defined as the ratio between the power the antenna radiates and the power put into the antenna by a coupled transmitter (or mirrored equivalently for receiving). Obviously, a high efficiency is usually desirable in an antenna.

The physical size of an antenna, normalized to its operating wavelength, usually refers in the art as the “electrical size” of the antenna, so a “small antenna” usually (including in the present document) means an Electrically Small Antenna (ESA). Clearly, small antennas are desirable, particularly in mobile and portable devices.

Ideally, a small and efficient antenna would be usually chosen, however, a well known rule trades off between the antenna physical size and its electrical efficiency, limiting the miniaturization of the electrical size of an antenna, for a given efficiency. Further known in the art that antennas should typically obtain at least one dimension not less than λ/4, where λ, (lambda) is the transmission (or reception) wavelength, to achieve fair efficient radiation. For example, a λ/4 monopole antenna for 406 MHz is about 18.5 cm long. Smaller than λ/4 antennas can be configured, yet this typically degrades the antenna efficiency.

Over the years, more complex shapes of antennas, many of them three dimensional, were been studied. Some fundamental works were been published by Wheeler [H. A. Wheeler, “Fundamental Limits of Small Antennas,” Proceedings of The I.R.E. (IEEE), December 1947, pg. 1479-1484], Chu (Chu, L. J, “Physical Limitation of Omni-Directional Antennas”, Journal of Applied Physics, Vol. 19, p. 1163-1175, 12/1948) and others. Based on these works, theoretical arguments predict that the minimal size for practical antennas will require a volume of half a sphere with a radius r, where kr=0.3 (k=2π/λ). For example, at 406 MHz this means a radius r of ˜4 cm. In part of the literature the radius of this sphere is named a instead of r, so ka=0.3 is considered the minimum figure for an efficient ESA. As well known in the art, another disadvantage of ESAs is narrow bandwidth, related to a high Q (quality factor). The minimum Q of an ESA was studied by James S. McLean, and published in “A Re-Examination of the Fundamental Limits on The Radiation Q of Electrically Small Antennas,” IEEE Transactions on Antennas and Propagation Vol 44, NO. 5, May 1996, pg. 672-675. McLean expressed the minimum Q for an ESA in free space, for linear or circular polarization, as a function of ka. As expected, Q increases as ka decreases, i.e. as an ESA gets smaller, its bandwidth gets narrower.

Furthermore, in almost any practical environment an electrically small antenna is near and particularly above a ground plane. This practical aspect was studied by Randy Bancroft from Centurion Wireless Technologies, Westminster, Colo. and published in: “Fundamental Dimension Limits of Antennas Ensuring Proper Antenna Dimensions in Mobile Device Designs”—http://www.cs.berkeley.edu/˜culler/AIIT/papers/radio/antenna%20wp_dimension_limits.pdf

Another important paper that studies the ESAs Q in the environment of a ground plane was published by Johan C. E. Sten, Arto Hujanen, and Paivi K. Koivisto, named: “Quality Factor of an Electrically Small Antenna Radiating Close to a Conducting Plane,” IEEE Transactions on Antennas and Propagation, VOL. 49, NO. 5 May 2001, pp. 829-837.

Obviously, a narrow bandwidth is inconvenient. Even if coupled to a wireless device configured to operate within this narrow band, the antenna might still detune due to rain, snow, dust etc.

It is therefore not easy to design a small antenna (ESA), efficient and wide band, operating in the vicinity of a ground plane, particularly for applications that require high elevation radiation patterns, such as those that involve satellite communications (including the private case of satellite navigation).

ESAs are particularly challenging for portable communication devices operating on a relatively low frequency as VHF or UHF, and mostly for wrist worn and other types of wearable devices.

One type of such portable communication device is a PLB (Personal Locator Beacon) for SAR (search and rescue) of people in distress. PLBs are tracking transmitters which aid in the detection and location of people in distress. When activated, PLBs transmit distress signals, typically detected by satellites and routed to terrestrial stations that decode the PLB position and accordingly guide rescue efforts.

The most prominent worldwide satellite SAR system (and organization) is Cospas-Sarsat that since its establishment in 1982, assisted in the rescue of over 30,000 people in more than 7,000 distress situations. Further information about Cospas-Sarsat can be found at http://cospas-sarsat.org/.

Cospas-Sarsat beacons utilize the frequency band of 406.0-406.1 MHz. Another regulated SAR frequency is 121.5 MHz, monitored by civil aircraft. The military airborne emergency frequency is 243 MHz.

As by the end of 2012, about 1.2 million Cospas-Sarsat compatible beacons (mostly PLBs—for personal use, but also EPIRBs—for ships, and ELTs—for aircraft) are deployed worldwide.

A wrist worn PLB is particularly useful, since it is comfortable to carry on a regular basis, and considering that distress situations can happen unexpectedly, for example, falling overboard a vessel, bumping into a snow avalanche, or crashing with a bicycle/motorcycle off road. In such a scenario, a handy PLB can make the difference between life and death.

U.S. Pat. No. 5,559,760 to Schneider (Breitling), discloses a wristwatch comprising, in addition to a device for measuring and displaying the time, a high-frequency transmitter and an extensible antenna in the form of two wires wound up in two different housings of the watch before use; the antenna being unfurled by pulling on plugs fastened to each end of the antennas. The dipole antenna of this device is configured that once been extended, remains straight.

Such stowed antenna enables a compact device that can be comfortably carried continuously, however when deployed, such a relatively long antenna is not practical to handle.

U.S. Pat. No. 7,586,463 to Katz discloses Extendable helical antenna for personal communication device. Katz claims “a helical antenna placed over a ground plane, packaged in a case with a rigid cover . . . said helical antenna made of an elastic conductive spring configured to change its height along its axis . . . pressed down between said case and said cover . . . or extended to a higher height improving antenna gain upon removing said cover . . . ”

Still, the extended helical antenna limits the user in distress in running or hiking, skiing, and so on.

So, while present art solutions provide quite a compact device when the antenna is stowed, they fail from providing a device which could be practically handled when the antenna is deployed.

U.S. Pat. No. 7,038,634 to Bisig discloses Optimization of a loop antenna geometry embedded in a wristband portion of a watch. Bisig discloses a loop antenna embedded in the wrist band of a watch, applied to receive FM radio broadcast.

U.S. Pat. No. 5,128,686 to Tan et al discloses Reactance buffered loop antenna, in which a loop antenna embedded in a wrist band could be adjusted in length to match different wrist diameters, and still match the operating frequency of a coupled receiver.

Such antennas typically obtain low efficiency, which could be sometimes tolerated by receivers however not by transmitters.

U.S. Pat. No. 5,659,325 to Belcher et, al discloses Low impedance loop antenna and drive circuitry, in which a flat loop antenna is embedded in a wrist worn device, in form of a band, wherein the flat sides of the band are normal to the plane of the loop, and the band edges parallel to the human body. The orientation of the loop antenna relative to the human body minimizes the capacitive effect of the human body on the loop antenna and thus decreases the impedance to the flow of current through the loop antenna.

Clearly such construction requires a relatively high profile wrist worn device, which is not desirable.

U.S. Pat. No. 8,164,529 to Parsche et al. discloses a Loop antenna including impedance tuning gap and associated methods. Parsche teaches a loop antenna comprising two gaps, one gap defining a signal feed point and the other gap defining an impedance tuning feature; further according to Parsche, an optional variable capacitor may be configured across the second gap.

Present art methods have not yet provided satisfactory solutions for a compact and efficient antenna for portable communication devices, particularly wearable devices, operating on a relatively low frequency band such as VHF or UHF.

It is then an object of the present invention to provide a portable communication device, compact enough to be carried by a person on a regular basis, still obtaining an efficient antenna.

It is also an object of the present invention to provide a portable communication device, in a compact wrist worn form, with an antenna efficient enough to enable communication with satellites.

It is another object of the present invention to provide a compact personal communication device, comprising an integral efficient antenna, and also means to indicate the time, and possibly measure and indicate additional parameters such as: temperature (body/ambient), pressure (air/water), heart rate, position, altitude, and so on.

It is yet another object of the present invention to provide a personal communication device comprising an efficient built in antenna, still giving room for a built in display, typically used to indicate the present time or position or other parameters relevant to the user.

It is still an object of the present invention to provide a personal wrist worn communication device with an integral antenna that is efficient, low profile, and aesthetically integrated with the product design, for example implemented as a bezel or ring or a decorative frame on top of the device.

It is yet an object of the present invention to provide a compact wireless communication device with an integral efficient antenna, obtaining at least two configurations: (a) stowed antenna, where the device achieves a low profile; (b) deployed antenna, where the antenna extends to achieve a better electrical performance.

It is yet also an object of the present invention to provide a compact and efficient antenna, which could be easily manufactured at a low cost.

Other objects and advantages of the invention will become apparent as the description proceeds.

### SUMMARY OF THE INVENTION

The present invention discloses a communication device comprising a radio coupled to an antenna, said radio at least one of: a transmitter or a receiver; said antenna comprising: a ground plane, a radiating wire, a feeding leg and a shorting leg; said radiating wire configured substantially on a plane parallel to said ground plane, and bent substantially following the perimeter of said ground plane; said feeding leg connecting said radio to a first point on said radiating wire and said shorting leg connecting said ground plane to a second point on said radiating wire, wherein both feeding leg and shorting leg configured substantially perpendicular to said ground plane.

According to a preferred embodiment of the present invention, the communication device is configured to be worn on a human body, particularly on the wrist, and said ground plane is configured between the human body and said radiating wire. According to this first and preferred embodiment, said radio is a UHF transmitter, configured to broadcast distress signals detectable by satellites, for search and rescue (SAR) purposes.

As a person skilled in the art may appreciate, it is not easy to design an efficient antenna constraint to a relatively low volume. This is, for example, the case with the first embodiment of the present invention, where a UHF antenna, in the 406 MHz band, i.e. wavelength=74 cm, is configured in a wrist worn device, typically in form of a cylinder with about 5 cm base diameter and 2 cm in height. According to this first embodiment, the RF transmission power of the radio is about 4 watts, and the radiation pattern is configured to cover 0-360 degrees in azimuth, and 0-50 degrees in elevation, at about −3 dB of antenna gain, in order to be detectable by LEO (Low Earth Orbit) and MEO (Medium Earth Orbit) and GEO (Geostationary) SAR satellites.

Typically, carefully designed patch antennas, or PIFA (Planar Inverted F Antennas), can do this job, particularly using high dielectric substrates, however, the present invention is further challenged with a human interface for said communication device, particularly a display, requiring “prime location real estate” on top of the device. This required coexistence of antenna and display presents additional complexity to the antenna design, as the display is both disturbing to and disturbed by the antenna, in terms of both mechanical design and electrical performance.

Explicitly, according to the preferred embodiment of the present invention, said communication device further comprises at least one human input or output device, configured on said ground plane and surrounded but not obstructed by said radiating wire. Preferably, said output device is a display, configured to indicate the time, but also possibly display position, speed, distance made good or calculated to a waypoint, altitude and air pressure, water depth, direction to a waypoint and particularly to the north, ambient temperature and body temperature, heart rate, blood pressure, received message, transmitted message, alarm, etc. Such displayed parameters, and others as the skilled person may appreciate, can serve a variety of applications, combining the communication abilities of the device with other functions, particularly those required at outdoors activities, such as: travelling, hiking, skiing, flying, sailing, windsurfing, diving, and so on.

Hence, due to the need to accommodate a display, or similar input/output device, on the upper face of the device, where it is friendly for the user to operate, but also the natural place for the antenna, particularly when considering satellite communication/navigation, the present invention presents an antenna placed on the upper outer border of the device.

This antenna, according to the present invention, obtains a basic F-inverted topology, i.e. feeding leg and shorting (grounding) leg perpendicularly connected to the main radiating element, however this element, according to the present invention and differently from present art IFA (Inverted F Antenna), is not a straight line but forming a bent line, and not on the antenna ground plane but on a plane parallel to the ground plane; further according to the present invention and differently from present art PIFA (Planar Inverted F Antenna), the radiating element is a “wire”, i.e. a conductor shaped with a considerable length but small width and small height (such as a typical copper wire or trace on a PCB), and typically not with large area, so not considered a planar antenna. Furthermore, according to the present invention, the radiating wire is bent substantially following the perimeter of the ground plane below it, so placed on the edge or out border of the device, hence less disturbing or being disturbed by a display placed on the middle of said ground plane.

As a person skilled in the art may appreciate, the distance between the feeding leg and the shorting leg, which are substantially parallel to each other, could be adjusted to optimize the matching, i.e. minimize the return loss at a specific frequency. Typically, with a rectangular ground plane of 40×50 mm, or a round ground plane with 50 mm in diameter, a distance of 10 mm between feeding leg and shorting leg provided good matching of −20 dB return loss or better, at a resonance frequency of 406 MHz, obtaining about 3% bandwidth (between −10 dB points). Typically at these conditions, the radiating wire was placed about 15 mm above ground plane, and its length was more or less similar to the ground plane circumference, i.e. 15-20 cm, more or less a quarter wavelength at 406 MHz.

Such dimensions enable integrating said radiating wire in or with a bezel or a ring or a decorative frame on top of said device, as such decorative elements are often part of a wrist watch artistic design.

Preferably, the radiating wire is configured in an electrically open loop, having a gap near the shorting leg. It is also possibly to close this loop, typically with a capacitor.

Furthermore, according to the present invention, the radiating wire might overlap itself near said gap, which is quite uncommon in inverted F antenna present art. Such feature provides an additional tool to adjust the resonance frequency of the antenna according to the present invention, even when there is less flexibility in varying the ground plane dimensions.

Further, according to the present invention, it is possible to configure the radiating wire to change its distance from said ground plane, obtaining at least two positions: (a) stowed position, where the radiating wire is close to the ground plane; (b) deployed position, where the distance between the ground plane and the radiating wire plane is larger. Preferably, both feeding leg and shorting leg can be made of elastic conductors, which collapse in the stowed position but strictly erected in the deployed position. When deployed, the radiating wire can be supported by a non conductive structure, such as two or three plastic shafts.

The present invention further discloses an antenna for a communication device, comprising: a ground plane, a radiating wire, a feeding leg and a shorting leg; said radiating wire configured substantially on a plane parallel to said ground plane, and bent substantially following the perimeter of said ground plane; said feeding leg configured to convey a radio signal to or from a first point on said radiating wire and said shorting leg connecting said ground plane to a second point on said radiating wire, wherein both feeding leg and shorting leg configured substantially perpendicular to said ground plane.

Preferably, the radiating wire of the antenna according to the present invention is further configured to surround but not obstruct a human input or output device placed on said ground plane.

Preferably, said output device placed on said ground plane of the antenna according to the present invention is configured to indicate at least one of: time, position, speed, distance, altitude, direction, temperature, air pressure, water depth, heart rate, blood pressure, received message, transmitted message, alarm.

According to a preferred embodiment of the present invention, the communication device comprising the present invention antenna is configured to be worn on a human body, wherein the antenna ground plane is configured between the human body and said radiating wire.

Possibly, in the antenna according to the present invention, said radiating wire is integrated in or with a bezel or a ring or a decorative frame on top of said communication device.

Preferably, in the antenna according to the present invention, the radiating wire is configured in an electrically open loop, having a gap near the shorting leg.

Possibly, in the antenna according to the present invention, the radiating wire is overlapped near said gap.

Possibly, in the antenna according to the present invention, said radiating wire is configured to change its distance from said ground plane, obtaining at least two positions: (a) stowed position, where the radiating wire is close to the ground plane; (b) deployed position, where the distance between the ground plane and the radiating wire plane is larger.

The present invention also discloses a method for configuring an antenna in a communication device, comprising the steps of:
a. Configuring a radio, being a transmitter or a receiver or a transceiver, on a ground plane;
b. Configuring a feeding leg from said radio, substantially perpendicular to said ground plane;
c. Configuring a shorting leg from said ground plane, substantially perpendicular to said ground plane;
d. Configuring a radiating wire, substantially on a plane parallel to said ground plane, and bent substantially following the perimeter of said ground plane;
e. Coupling said radio, via said feeding leg, to a first point on said radiating wire;
f. Coupling said ground plane, via said shorting leg, to a second point on said radiating wire;
g. Adjusting the distance between said first point and said second point to minimize reflection;
h. Adjusting the length of said radiating wire to match a specific frequency.

Further step, according to the present invention method, is configuring on said ground plane at least one of: a human input or output device surrounded but not obstructed by said radiating wire.

The output device according to the present invention method may be configured to indicate at least one of: time, position, speed, distance, altitude, direction, temperature, air pressure, water depth, heart pace, blood pressure, received message, transmitted message, and alarm.

A further step related to said method according to the present invention is configuring the radiating wire to change its distance from said ground plane, obtaining at least two positions: (a) stowed position, where the radiating wire is close to the ground plane; (b) deployed position, where the distance between the ground plane and the radiating wire plane is larger.

Other objects and advantages of the invention will become apparent as the description proceeds.

### BRIEF DESCRIPTION OF THE DRAWINGS

The above and other characteristics and advantages of the invention will be better understood through the following illustrative and non-limitative detailed description of preferred embodiments thereof, with reference to the appended drawings, wherein:

FIG. 1 shows a Round Wire Inverted F Antenna according to the present invention: (a) in top view, and (b) in side view. The figure shows a radiating wire in a circular shape, over a similarly round ground plane, where the radiating wire is placed on a plane substantially parallel to said ground plane (side view) and over the edge of the round ground plane (top view). The radiating wire is in open loop, i.e. a narrow gap is interrupting the wire from forming a closed loop. Two conductors are shown perpendicular to the ground plane: a feeding leg which connects a radio, placed on the ground plane (shown in the top view) to a first point on the radiating wire, and a shorting leg, connecting the ground plane to a second point on the radiating wire.

FIG. 2 shows a Rectangular Wire Inverted F Antenna according to the present invention: (a) in top view, and (b) in side view. The figure shows a radiating wire in a rectangular shape, over a similarly rectangular ground plane, where the radiating wire is placed on a plane substantially parallel to said ground plane (side view) and over the edge of the rectangular ground plane (top view). The radiating wire is in open loop, i.e. a narrow gap is interrupting the wire from forming a closed loop. Two conductors are shown perpendicular to the ground plane: a feeding leg which connects a radio, placed on the ground plane (shown in the top view) to a first point on the radiating wire, and a shorting leg, connecting the ground plane to a second point on the radiating wire.

FIG. 3 shows an Inverted F Antenna with overlapped Radiating Wire according to the present invention: (a) in top view, and (b) in side view. The figure shows a radiating wire in a rectangular shape, over a ground plane, where the radiating wire is placed on a plane substantially parallel to said ground plane (side view) and over the edge of said ground plane (top view). The radiating wire is in open loop, i.e. a narrow gap is interrupting the wire from forming a closed loop. Two conductors are shown perpendicular to the ground plane: a feeding leg which connects a radio (not shown) to a first point on the radiating wire, and a shorting leg, connecting the ground plane to a second point on the radiating wire. Near the shorting leg, the radiating wire is shown to continue over the gap, say from right to left, and form a certain overlap with the part of the wire on the left side of the gap; however there is no direct galvanic connection between the overlapped portions of the radiating wire. In other words, the gap is not shortened by the overlapped radiating wire.

FIG. 4 shows a Rectangular Wire Inverted F Antenna Integrated with Display according to the present invention: (a) in top view, and (b) in side view. The figure shows a radiating wire in a rectangular shape, over a similarly shaped rectangular ground plane, where the radiating wire is placed on a plane substantially parallel to said ground plane (side view) and over the edge of said ground plane (top view). The radiating wire is in open loop, i.e. a narrow gap is interrupting the wire from forming a closed loop. Two conductors are shown perpendicular to the ground plane: a feeding leg which connects a radio, placed on the ground plane (shown in the top view) to a first point on the radiating wire, and a shorting leg, connecting the ground plane to a second point on the radiating wire. Further, a display is shown placed on the ground plane, wherein the radiating wire surrounds but does not obstruct the display.

FIG. 5 illustrates a Wrist Worn Communication Device according to the present invention. The device is shown worn on a human wrist, in (a) top view and (b) side view. It can be seen (side view) that the ground plane is configured between the wrist and the radiating wire, and (top view) that the display is surrounded but not obstructed by the radiating wire, from a user point of view.

FIG. 6 illustrates a Wrist Worn Communication Device with Antenna Integrated in Bezel. The figure shows a wrist wearable device, with two straps configured to hold the device on the wrist, a display on top indicating the time of day by two watch hands, the short hand indicating the hour and the long hand indicating the minute. The display is surrounded by a circular bezel, and it is indicated that an antenna is integrated in the bezel, i.e. the radiating wire of the antenna is integrated in the bezel, according to the present invention. By the bottom side of the wrist worn device (which is typically placed on the wrist, the presence of the antenna ground plane is indicated.

FIG. 7 shows a Wire Inverted F Antenna with Two Positions, according to the present invention, in (a) stowed position; and (b) deployed position. Both (a) and (b) show, in side view, a radiating wire placed in parallel to and over a ground plane, with a feeding leg and shorting leg perpendicular to the ground plane. Also, a display is shown on the ground plane. In the stowed position (a) the radiating wire is shown closer to the ground plane than in the deployed position (b).

FIG. 8 depicts a Block Diagram of Communication Device with Wire Inverted F Antenna according to a preferred embodiment of the present invention. The radio is a UHF transmitter, coupled to a wire inverted F antenna according to the present invention, and on the other side coupled to a micro controller. Through another port, the microcontroller is coupled to a GPS receiver, wherein the GPS receiver is coupled to a GPS antenna via an LNA and SAW filter. The picture also shows input and output devices coupled to the microcontroller, as well as sensors.

FIG. 9 illustrates a Wrist Worn Communication Device In background of Satellite System, according to a preferred embodiment of the present invention. A human hand is depicted, with a communication device, shown in side view (cut section) mounted on the wrist. The side view of the communication device shows a radiating wire placed over a ground plane (ground plane close to wrist), with a feeding leg and shorting leg perpendicular to the ground plane. Also, a display and a GPS antenna are shown on the ground plane. GPS satellites are illustrated on the upper part of the figure, broadcasting signals apparently arriving to the GPS antenna, while the radiating wire on top of the communication device is shown transmitting a signal arriving at the illustrated SAR satellite on the upper part of the picture.

### DETAILED DESCRIPTION

The present invention discloses a communication device comprising a radio coupled to an antenna, said radio at least one of: a transmitter or a receiver; said antenna comprising: a ground plane, a radiating wire, a feeding leg and a shorting leg; said radiating wire configured substantially on a plane parallel to said ground plane, and bent substantially following the perimeter of said ground plane; said feeding leg connecting said radio to a first point on said radiating wire and said shorting leg connecting said ground plane to a second point on said radiating wire, wherein both feeding leg and shorting leg configured substantially perpendicular to said ground plane.

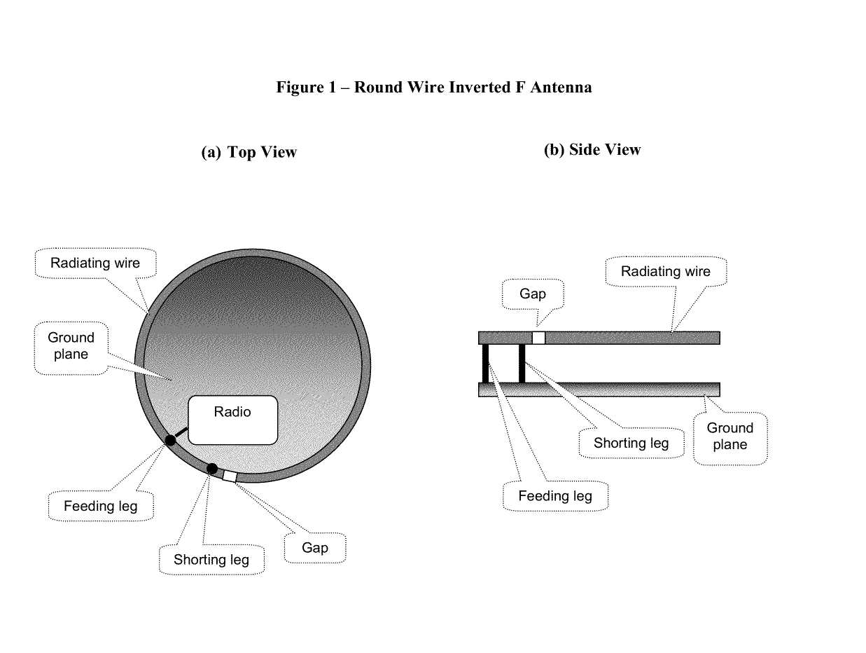

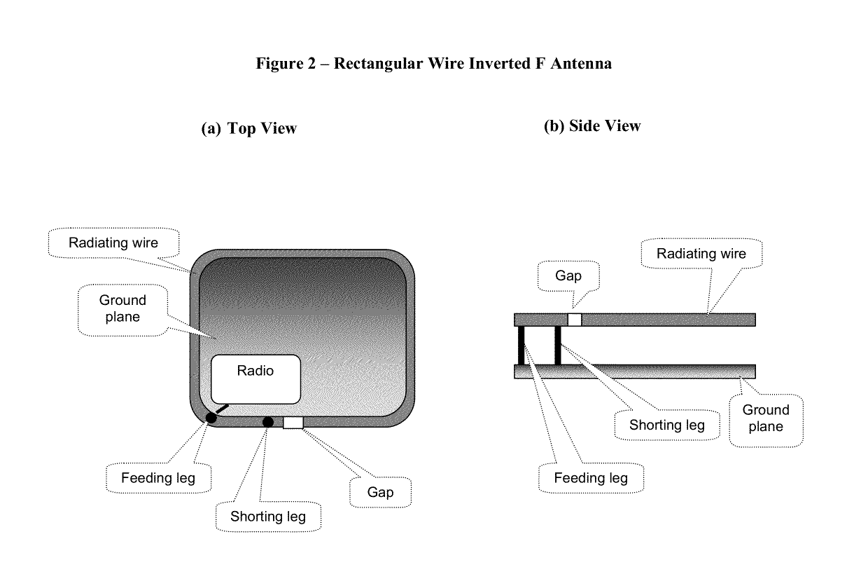

FIG. 1 shows a Round Wire Inverted F Antenna according to the present invention: (a) in top view, and (b) in side view. FIG. 2 shows a Rectangular Wire Inverted F Antenna according to the present invention: (a) in top view, and (b) in side view. FIG. 1 and FIG. 2 depict a radiating wire, in a circular shape (FIG. 1) or rectangular shape (FIG. 2), over a similarly circular (FIG. 1) or rectangular (FIG. 2) ground plane, where the radiating wire is placed on a plane substantially parallel to said ground plane (side view) and over the edge of said ground plane (top view). The radiating wire is in open loop, i.e. a narrow gap is interrupting the wire from forming a closed loop. Two conductors are shown perpendicular to the ground plane: a feeding leg which connects a radio, placed on the ground plane (shown in the top view) to a first point on the radiating wire, and a shorting leg, connecting the ground plane to a second point on the radiating wire.

According to a first and preferred embodiment of the present invention, said radio is a UHF transmitter, configured to broadcast distress signals, for search and rescue (SAR) purposes, at about 4 watts and in the 406 MHz band, i.e. wavelength=74 cm. Then, the diameter of the ground plane in FIG. 1 is about 50 mm, and the dimensions of the rectangular ground plane in FIG. 2 are about 40×50 mm. In both cases, the radiating wire is placed about 15 mm above ground plane, and its length is more or less similar to the ground plane circumference, i.e. 15-20 cm, about a quarter wavelength at 406 MHz. The radiating wire may obtain diverse cross section dimensions, such as round 1 mm diameter, or a PCB trace 1-2 mm wide. As a person skilled in the art may appreciate, the distance between the feeding leg and the shorting leg can be adjusted to optimize the matching, i.e. minimize the return loss at a specific frequency. Typically, with a rectangular ground plane of 40×50 mm, or round ground plane with 50 mm in diameter, a distance of 10 mm between feeding leg and shorting leg provides good matching of −20 dB return loss or better, at a resonance frequency of 406 MHz, with about 3% bandwidth (between −10 dB points).

As a person skilled in the art may appreciate, the form of the ground plane (and accordingly the form of the radiating wire) in this antenna may vary, configured for example to be triangular, square, pentagonal, hexagonal, octagonal, rhombus, trapezoid, or any other polygon, or have rounded sides e.g. oval, or actually have any two dimensional shape, provided that the radiating wire is configured to substantially follow the outer border of said ground plane.

Also, it is probably clear to the skilled person that configuring the radiating wire bent substantially following the perimeter of said ground plane, does not mean that said radiating wire should be exactly over said perimeter, and obtain length exactly equal to said ground plane circumference, but rather substantially or significantly be so. Furthermore, trimming the radiating wire footprint over the ground plane a bit inside or outside of the ground plane perimeter may be used to adjust the antenna radiation pattern.

For both round and rectangular antennas, configured to 406 MHz according to a preferred embodiment of the present invention, the radiation pattern was measured to cover 0-360 degrees in azimuth, and 0-50 degrees in elevation, at about −3 dB antenna gain. In these cases, the major part of antenna radiation power was in vertical polarization.

Further observing the radiating wire depicted in FIG. 1 and FIG. 2, it is shown to follow the ground plane perimeter, say in clockwise direction starting from the shorting leg, forming kind of a loop, until returning to its starting point by the shorting leg. There, a gap is shown, interrupting the radiating wire from closing a conductive loop. This typically 2-5 mm gap is configured between the two ends of the radiating wire, according to the preferred embodiment of the present invention. Still, according to other embodiments of the present invention, that gap might be closed, i.e. shorted, or could be linked by an electrical component such as a capacitor. As a person skilled in the art may appreciate, such electrical loading can be used to trim the antenna to a desired frequency. In particular, a capacitor can be placed over this gap to trim a relatively short radiating wire to a relatively low operating frequency. Obviously, a too short radiating wire might be trimmed to a relatively low operating frequency simply by making it longer. In case that the ground plane circumference is too short for an accordingly radiating wire to match a certain frequency, it is possible to lengthen the radiating wire by adding an overlapped segment, still kept substantially over the ground plane perimeter.

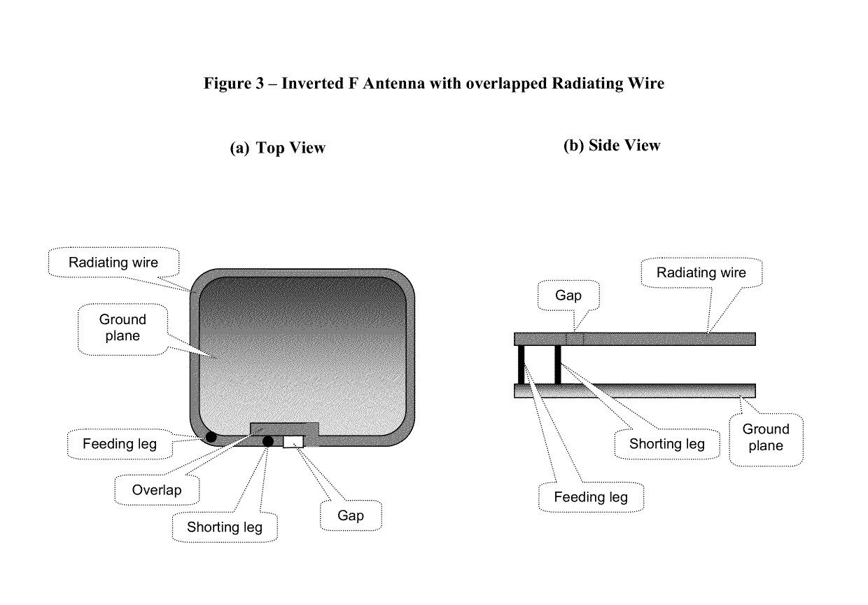

FIG. 3 shows an Inverted F Antenna with overlapped Radiating Wire according to the present invention: (a) in top view, and (b) in side view. The figure shows a radiating wire in a rectangular shape, over a similarly rectangular ground plane, where the radiating wire is placed on a plane substantially parallel to said ground plane (side view) and over the edge of said ground plane (top view). Two conductors are shown perpendicular to the ground plane: a feeding leg which connects a radio (not shown) to a first point on the radiating wire, and a shorting leg, connecting the ground plane to a second point on the radiating wire. A narrow gap is shown preventing the radiating wire from conductively closing the loop formed over the ground plane circumference. Further, the radiating wire is shown to continue over the gap, forming a certain overlap with the part of the wire on the left side of the gap; however there is no direct galvanic connection between the overlapped portions of the radiating wire. As a person skilled in the art may appreciate, these parallel overlapped portions of the radiating wire can be implemented alongside on the same plane, but also on different PCB layers, i.e. not exactly but substantially on the same plane.

According to the preferred embodiment of the present invention, the communication device further comprises at least one human input or output device, configured on the ground plane and surrounded but not obstructed by the radiating wire. Preferably, said output device is a display, configured to indicate the time, but also possibly display position, speed, distance made good or calculated to a waypoint, altitude and air pressure, water depth, direction to a waypoint and particularly to the north, ambient temperature and body temperature, heart rate, blood pressure, received message, transmitted message, alarm, etc. Such displayed data, and other as the skilled person may appreciate, can serve a variety of applications, combining the communication abilities of the device with other functions, particularly those required at outdoors activities, such as: travelling, hiking, skiing, flying, sailing, windsurfing, diving, and so on.

Hence, the need to accommodate a display, or similar input/output device, in the middle and upper side of the device, is answered by an antenna, specifically a radiating wire, configured by the outer border of the device, thus less disturbing or being disturbed by said display.

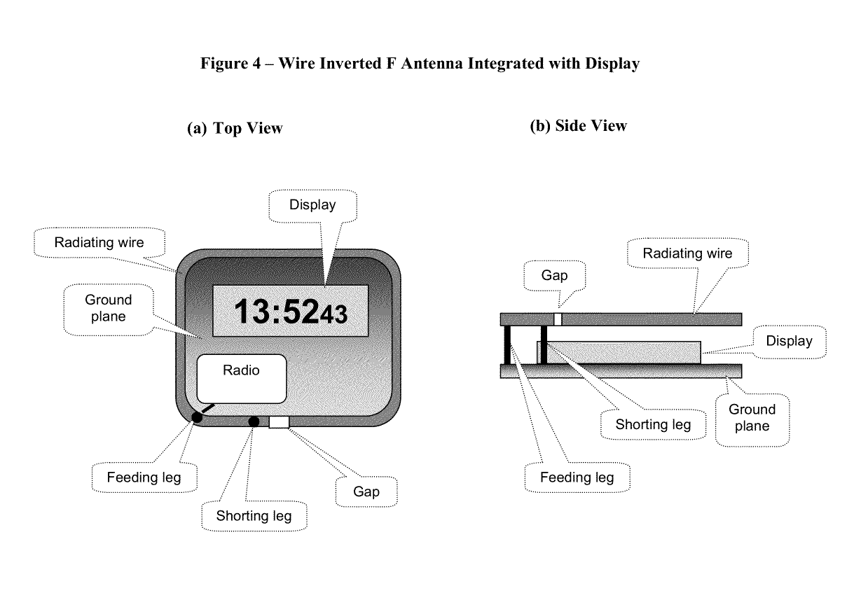

FIG. 4 shows a Rectangular Wire Inverted F Antenna Integrated with Display according to the present invention: (a) in top view, and (b) in side view. The figure shows a radiating wire in a rectangular shape, over a ground plane, where the radiating wire is placed in parallel to and over the edge of the rectangular ground plane. A display is shown placed on the ground plane, and clearly, the radiating wire surrounds but does not obstruct the display, from a user point of view.

According to a second embodiment of the present invention, the radio is a GNSS (Global Navigation Satellite System) receiver, e.g. the US GPS or Russian GLONASS or European Galileo, but particularly compatible with the US Global Positioning System (GPS). Then, the antenna is configured to the 1575 MHz band, where a quarter wave length is equal to about 5 cm. In this case, the ground plane can be configured to a circumference of about 5 cm, or larger and then the radiating wire would probably not cover all that circumference but obtain a relatively large gap between its ends.

Further according to a preferred embodiment of the present invention, the communication device is configured to be worn on a human body, particularly on the wrist, wherein the ground plane configured between the human body and the radiating wire.

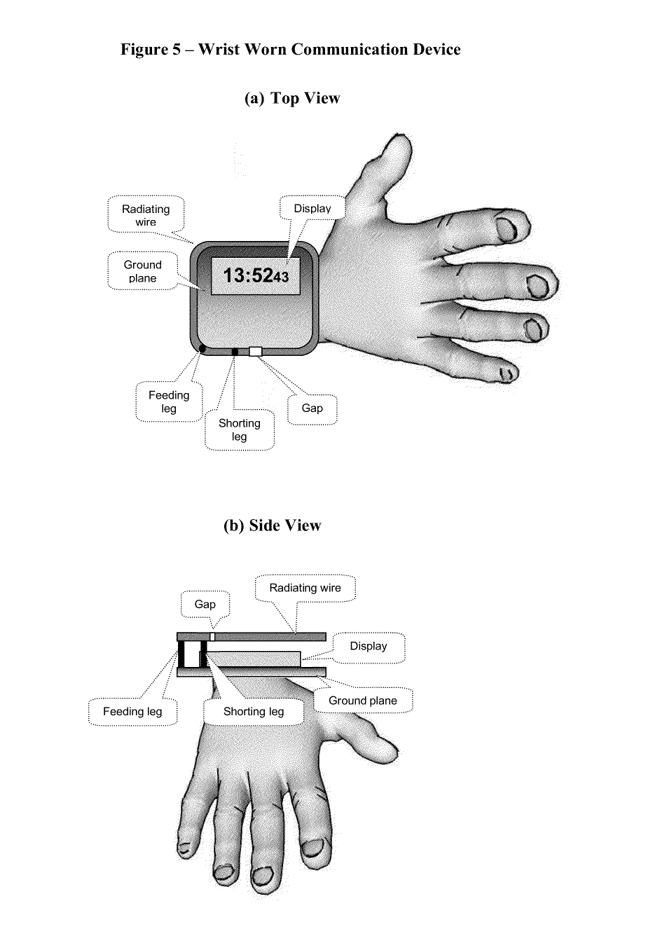

FIG. 5 illustrates a Wrist Worn Communication Device according to the present invention. The device is shown worn on a human wrist, in (a) top view and (b) side view. It can be seen (side view), that the device is configured with the ground plane between the wrist and the radiating wire, and that the display is surrounded but not obstructed by the radiating wire (top view), from the user point of view. As a person skilled in the art may appreciate, placing the ground plane between the human body and the radiating wire is advantageously since more radiation is directed away from the human body, providing better communications and less health problems.

Further, configuring the radiating wire of the antenna on the outer upper border of the device, according to the present invention, enables integrating it with certain mechanical or artistic parts of the communication device. Particularly, when configured as a wrist worn device, and mostly when integrated with a wrist watch, it might make sense to integrate the radiating wire with or in a bezel or a ring or a decorative frame on top of said device, as such decorative elements are often part of a wrist watch design.

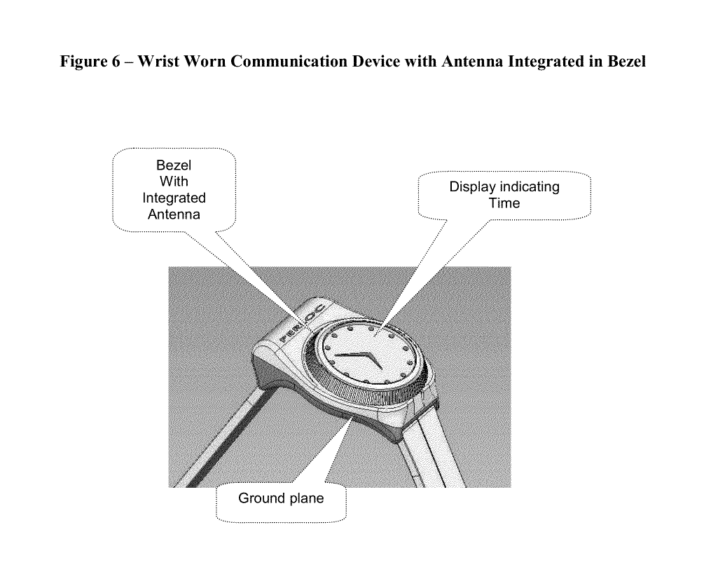

FIG. 6 illustrates a Wrist Worn Communication Device with Antenna Integrated in Bezel. The figure shows a wrist wearable device, with two straps configured to hold the device on the wrist, a display on top indicating the time of day by two watch hands (which may be physical or shapes displayed on an LCD, for example), the short hand indicating the hour and the long hand indicating the minute. The display is surrounded by a circular bezel, and it is indicated that an antenna (i.e. the radiating wire of the antenna), is integrated in that bezel. By the bottom side of the wearable device (which is typically placed near the wrist), the presence of a ground plane is indicated, where said ground is part of the antenna according to the present invention.

Further, according to the present invention, it is possible to configure the radiating wire to change its height above the ground plane, obtaining at least two positions: (a) stowed position, where the radiating wire is close to the ground plane; (b) deployed position, where the distance between the ground plane and the radiating wire plane is larger. This feature is useful for a device where the radio is not usually or not frequently operated, so the radio antenna may be usually stowed, providing a comfortable low profile device. Occasionally, the radio should be operated, such as in a distress situation, according to the preferred embodiment of the present invention, then the antenna can be easily deployed. As a person skilled in the art may appreciate, a certain minimal distance between the radiating wire and the ground plane is required in order to achieve a desirable antenna gain.

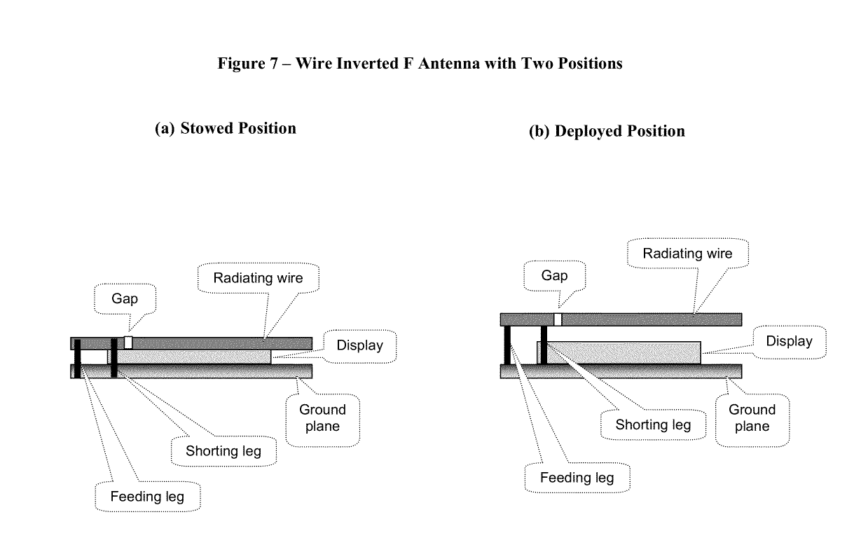

FIG. 7 shows a Wire Inverted F Antenna with Two Positions, according to the present invention, in (a) stowed position; and (b) deployed position. Both (a) and (b) show, in side view, a radiating wire placed in parallel to and over a ground plane, with a feeding leg and shorting leg perpendicular to said ground plane. In the stowed position (a) the radiating wire is shown closer to the ground plane than in the deployed position (b).

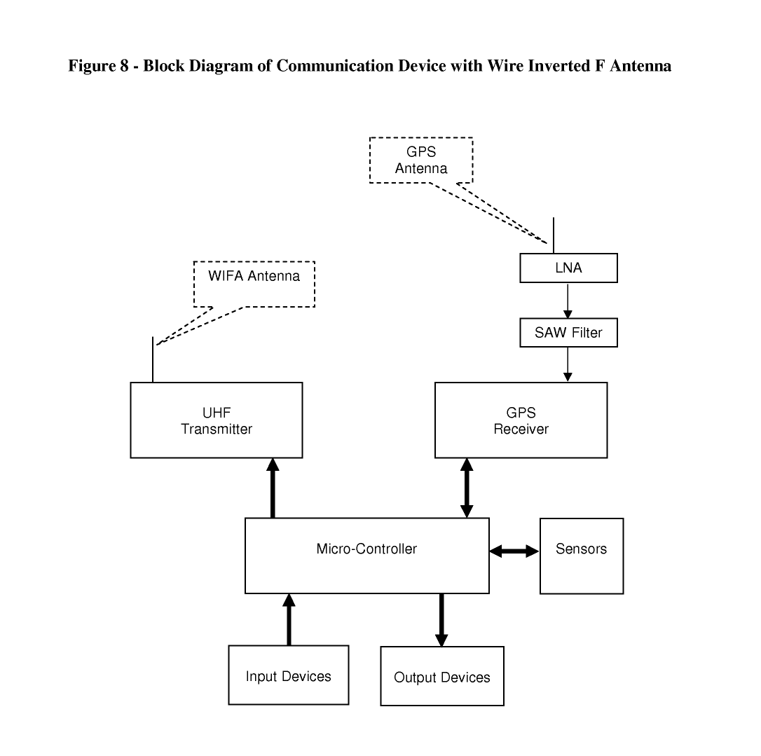

According to a third embodiment of the present invention, the communication device is wrist worn, as shown in FIG. 5, and the radiating wire is integrated in a bezel on top the device, as shown in FIG. 6. A display in configured on top of said device, surrounded but not obstructed by said bezel (as shown in FIG. 5), enabling the user to occasionally observe the time of day. Further, as generally shown in FIG. 7, the bezel with integrated radiating wire is configured to be usually close to the body of the device (typically about 1 cm above ground plane), yet alternatively shifted higher above the device upper side (and accordingly above the ground plane installed at the bottom side of the device, as shown in FIGS. 5, 6 and 7), positioning the antenna in better communication conditions. At the upper position, the bezel is mechanically locked to affirm a carefully pre-designed height (typically about 2 cm above ground plane). Preferably, the radiating wire is implemented on a PCB, and the bezel is made of non metallic material, which dielectric and permeability attributes should be considered for proper antenna matching. Alternatively, the bezel can be made of metal, actually implementing the radiating wire, taking into account a discontinuation required in the metallic structure of the bezel circumference in order to assure a proper gap, as shown in FIG. 7. The feeding leg and the shorting leg can be made of elastic conductors, or alternatively solid conductors attached to the radiating wire and sliding through proper connection places by the radio and ground plane accordingly. FIG. 8 depicts a Block Diagram of Communication Device with Wire Inverted F Antenna according to a fourth embodiment of the present invention. The radio is a UHF transmitter, coupled to a wire inverted F antenna according to the present invention, and also coupled to a microcontroller. From the other side, the microcontroller is coupled to a GPS receiver, wherein the GPS receiver is coupled to a GPS antenna via an LNA and SAW filter. The picture also shows input and output devices coupled to the microcontroller (typically press buttons or switches, LEDs, displays, touch screens and so on), as well as sensors (typically sensing: temperature, altitude, the north direction, temperature, air pressure, water depth, heart rate, blood pressure, etc.). As a person skilled in the art may appreciate, said micro controller may further obtain short range connectivity (e.g. wired connectivity over USB or wireless connectivity over Bluetooth or Wi-Fi) with external devices, such as a heart rate monitoring device mounted on the chest, or a blood pressure monitoring device mounted on the other wrist.

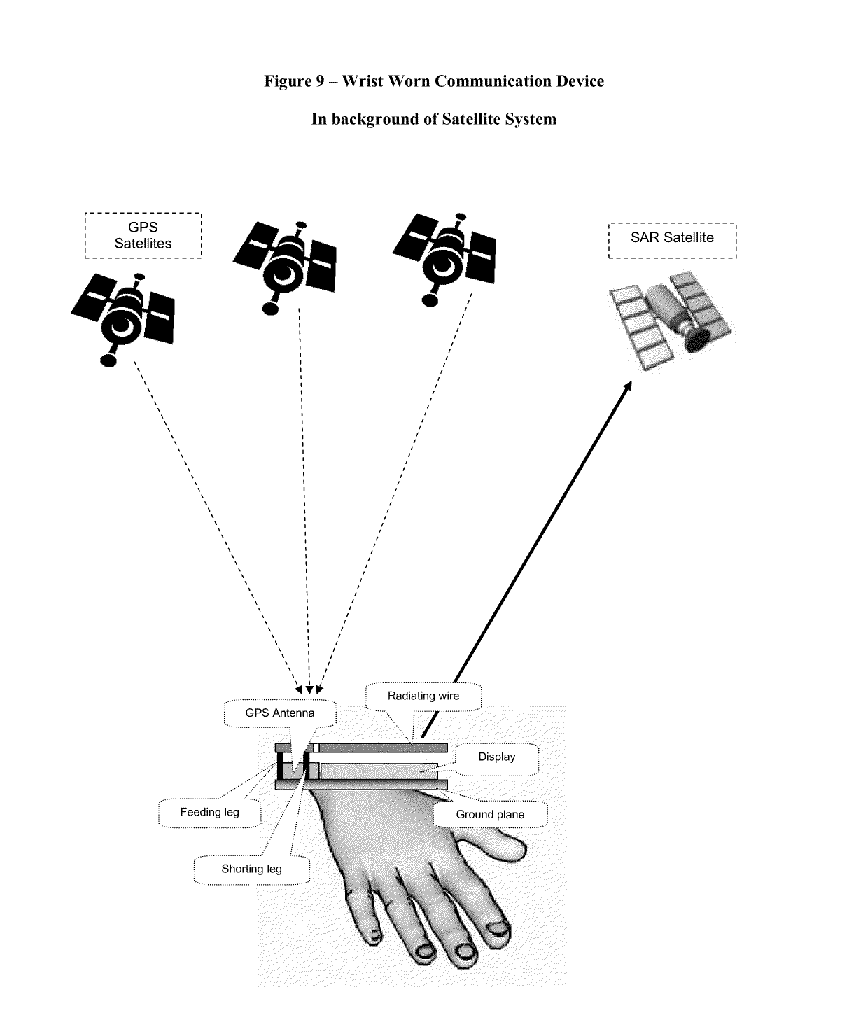

FIG. 9 illustrates a Wrist Worn Communication Device In background of Satellite System, according to said fourth embodiment of the present invention. A human hand is depicted, with a communication device, shown in (cut section) side view mounted on the wrist. The side view of the communication device shows a radiating wire placed in parallel and over a ground plane (ground plane close to wrist), with a feeding leg and shorting leg perpendicular to the ground plane. Also, a display and a GPS antenna are shown on the ground plane. GPS satellites are illustrated on the upper part of the figure, broadcasting signals apparently arriving to the GPS antenna, while the radiating wire on top of the communication device is shown transmitting a signal arriving at the illustrated SAR satellite on the upper part of the picture.

According to said fourth embodiment of the present invention, the communication device additionally comprises a temperature sensor, and a barometric pressure sensor, so the display may indicate in addition to the time of day (administered by the microcontroller) also: the temperature, barometric pressure and altitude above sea level, as well as the position acquired by the GPS receiver. FIG. 9 shows the GPS antenna, placed on top of the ground plane, by the display. As a person skilled in the art may appreciate, configuring the radiating wire of the UHF transmitter over the ground plane perimeter gives room not only for a display, but also enables said GPS antenna to have relatively unobstructed visibility of the sky, to properly receive the signals broadcast from GPS satellites.

The present invention further discloses an antenna for a communication device, comprising: a ground plane, a radiating wire, a feeding leg and a shorting leg; said radiating wire configured substantially on a plane parallel to said ground plane, and bent substantially following the perimeter of said ground plane; said feeding leg configured to convey a radio signal to or from a first point on said radiating wire and said shorting leg connecting said ground plane to a second point on said radiating wire, wherein both feeding leg and shorting leg configured substantially perpendicular to said ground plane.

Preferably, the radiating wire of the antenna according to the present invention is further configured to surround but not obstruct a human input or output device placed on said ground plane.

Preferably, said output device placed on said ground plane of the antenna according to the present invention is configured to indicate at least one of: time, position, speed, distance, altitude, direction, temperature, air pressure, water depth, heart rate, blood pressure, received message, transmitted message, alarm.

According to a preferred embodiment of the present invention, the communication device comprising the present invention antenna is configured to be worn on a human body, wherein the antenna ground plane is configured between the human body and said radiating wire.

Possibly, in the antenna according to the present invention, said radiating wire is integrated in or with a bezel or a ring or a decorative frame on top of said communication device.

Preferably, in the antenna according to the present invention, the radiating wire is configured in an electrically open loop, having a gap near the shorting leg.

Possibly, in the antenna according to the present invention, the radiating wire is overlapped near said gap.

Possibly, in the antenna according to the present invention, said radiating wire is configured to change its distance from said ground plane, obtaining at least two positions: (a) stowed position, where the radiating wire is close to the ground plane; (b) deployed position, where the distance between the ground plane and the radiating wire plane is larger.

The present invention also discloses a method for configuring an antenna in a communication device, comprising the steps of:
a. Configuring a radio, being a transmitter or a receiver or a transceiver, on a ground plane;
b. Configuring a feeding leg from said radio, substantially perpendicular to said ground plane;
c. Configuring a shorting leg from said ground plane, substantially perpendicular to said ground plane;
d. Configuring a radiating wire, substantially on a plane parallel to said ground plane, and bent substantially following the perimeter of said ground plane;
e. Coupling said radio, via said feeding leg, to a first point on said radiating wire;
f. Coupling said ground plane, via said shorting leg, to a second point on said radiating wire;
g. Adjusting the distance between said first point and said second point to minimize reflection;
h. Adjusting the length of said radiating wire to match a specific frequency.

Further step, according to the present invention method, is configuring on said ground plane at least one of: a human input or output device surrounded but not obstructed by said radiating wire.

The output device according to the present invention method may be configured to indicate at least one of: time, position, speed, distance, altitude, direction, temperature, air pressure, water depth, heart pace, blood pressure, received message, transmitted message, and alarm.

The radiating wire according to the present invention method may be configured to change its distance from said ground plane, obtaining at least two positions: (a) stowed position, where the radiating wire is close to the ground plane; (b) deployed position, where the distance between the ground plane and the radiating wire plane is larger.

The above examples and description have of course been provided only for the purpose of illustration, and are not intended to limit the invention in any way. As will be appreciated by the skilled person, the invention can be carried out in a great variety of ways, employing more than one technique from those described above, all without exceeding the scope of the invention. In this context, though the invention specifically refers to the Cospas-Sarsat satellite system, it is definitely not bounded to this particular system, and its scope is well beyond any specific communication or navigation system or any specific radio type or system or frequency.

The invention claimed is:

1. A communication device comprising a radio coupled to an antenna, said radio at least one of: a transmitter or a receiver; said antenna comprising: a ground plane, a radiating wire, a feeding leg and a shorting leg; said radiating wire configured substantially on a plane parallel to said ground plane, and bent substantially following the perimeter of said ground plane; said feeding leg connecting said radio to a first point on said radiating wire and said shorting leg connecting said ground plane to a second point on said radiating wire, wherein both feeding leg and shorting leg configured substantially perpendicular to said ground plane.

2. A device according to claim 1, further comprising at least one of: a human input or output device configured on said ground plane and surrounded but not obstructed by said radiating wire.

3. A communication device according to claim 2, wherein said output device configured to indicate at least one of: time, position, speed, distance, altitude, direction, temperature, air pressure, water depth, heart rate, blood pressure, received message, transmitted message, alarm.

4. A device according to claim 1, configured to be worn on a human body, wherein said ground plane configured between the human body and said radiating wire.

5. A device according to claim 1, said radiating wire integrated in or with a bezel or a ring or a decorative frame on top of said device.

6. A device according to claim 1, said radiating wire configured in an electrically open loop, having a gap near the shorting leg.

7. A device according to claim 6, wherein said radiating wire is overlapped near said gap.

8. A device according to claim 1, wherein said radiating wire configured to change its distance from said ground plane, obtaining at least two positions: (a) stowed position, where the radiating wire is close to the ground plane; (b) deployed position, where the distance between the ground plane and the radiating wire plane is larger.

9. An antenna for a communication device, comprising: a ground plane, a radiating wire, a feeding leg and a shorting leg; said radiating wire configured substantially on a plane parallel to said ground plane, and bent substantially following the perimeter of said ground plane; said feeding leg configured to convey a radio signal to or from a first point on said radiating wire and said shorting leg connecting said ground plane to a second point on said radiating wire, wherein both feeding leg and shorting leg configured substantially perpendicular to said ground plane.

10. An antenna according to claim 9, said radiating wire configured to surround but not obstruct a human input or output device placed on said ground plane.

11. An antenna according to claim 10, wherein said output device configured to indicate at least one of: time, position, speed, distance, altitude, direction, temperature, air pressure, water depth, heart rate, blood pressure, received message, transmitted message, alarm.

12. An antenna according to claim 9, said communication device configured to be worn on a human body, wherein said ground plane configured between the human body and said radiating wire.

13. An antenna according to claim 9, said radiating wire integrated in or with a bezel or a ring or a decorative frame on top of said communication device.

14. An antenna according to claim 9, said radiating wire configured in an electrically open loop, having a gap near the shorting leg.

15. An antenna according to claim 14, wherein said radiating wire is overlapped near said gap.

16. An antenna according to claim 9, wherein said radiating wire configured to change its distance from said ground plane, obtaining at least two positions: (a) stowed position, where the radiating wire is close to the ground plane; (b) deployed position, where the distance between the ground plane and the radiating wire plane is larger.

17. A method for configuring an antenna in a communication device, comprising the steps of:
a. Configuring a radio, being a transmitter or a receiver or a transceiver, on a ground plane;
b. Configuring a feeding leg from said radio, substantially perpendicular to said ground plane;
c. Configuring a shorting leg from said ground plane, substantially perpendicular to said ground plane;
d. Configuring a radiating wire, substantially on a plane parallel to said ground plane, and bent substantially following the perimeter of said ground plane;
e. Coupling said radio, via said feeding leg, to a first point on said radiating wire;
f. Coupling said ground plane, via said shorting leg, to a second point on said radiating wire;
g. Adjusting the distance between said first point and said second point to minimize reflection;
h. Adjusting the length of said radiating wire to match a specific frequency.

18. A method according to claim 17, further configuring on said ground plane at least one of: a human input or output device surrounded but not obstructed by said radiating wire.

19. A method according to claim 18, further configuring said output device to indicate at least one of: time, position, speed, distance, altitude, direction, temperature, air pressure, water depth, heart pace, blood pressure, received message, transmitted message, alarm.

20. A method according to claim 17, further configuring said radiating wire to change its distance from said ground plane, obtaining at least two positions: (a) stowed position, where the radiating wire is close to the ground plane; (b) deployed position, where the distance between the ground plane and the radiating wire plane is larger.
